(19) United States
(12) Patent Application Publication
(10) Pub. No.: US 2002/0096672 A1
(43) Pub. Date: Jul. 25, 2002

(54) Winch for sailboats

(75) Inventors: Andrea Merello, Genova (IT); Alberto Lozza, Cornaredo (MI) (IT)

Correspondence Address: Russell W. Pyle, Pyle & Piontek, Suite 850, 221 N. LaSalle St., Chicago, IL, 60601, US

(73) Assignee: Harken-Italy, Lurago Marinone (CO) (IT)

(21) Appl. No.: 09/769,664

(22) Filed: Jan. 25, 2001

(51) Int. Cl. B66D 1/14

(52) U.S. Cl. 254/342

(57) ABSTRACT

A winch for sailboats comprises a stator body intended to be integrally mounted on a deck of a sailboat, and a rotor body intended to house a rope for manoeuvring the sailboat. The rotor body is coaxially and turnably fitted onto the stator body along a primary rotation driving shaft. The winch also comprises a secondary motion transmission shaft in meshing engagement with the rotor body and a plurality of gears, between the primary shaft and the secondary shaft, intended to transmit the motion to the rotor body with a predetermined reduction ratio. The gears are housed into a box intended to be arranged below the boat deck. During maintenance operations, to access the gears it is sufficient to remove the gearbox from below deck; in the meantime, the winch can still perform its function of rope deviation.

### DESCRIPTION

The present invention relates to a winch for sailboats. In particular, the winch of the invention has a preferred but not exclusive application on racing and/or cruising sailboats.

As known, winches are used on sailboats to facilitate the manoeuvring and trimming of sails carrying a load, such as for example the operations of positioning and hoisting the sails. Said operations are carried out by manoeuvring suitable ropes (commonly referred to also with the terms of sheets or halyard) suitably connected to the sails; the ropes, in particular, are pulled by winding the same on proper winches suitably arranged on the deck of the boat. The ropes are then properly clamped through suitable locking means provided onto the winch or onto the boat, so as to keep the sails in the desired position.

Winches typically comprise a stator base body, or support, intended to be fastened to the sailboat deck, and a rotor body, or drum, turnably associated to the stator body and intended to house the windings of the sail for manoeuvring the rope during the pull operations of the rope. The rotor body is coaxially fitted onto the stator body along a primary rotation driving shaft, and it is kinetically connected to said shaft through a plurality of motion transmission and reduction gears.

The traction is applied to the rope by imparting a rotation to the primary shaft of the winch, for example through a handle or through suitable drive pedestals; said rotation is transferred to the rotor body, with a predetermined reduction gear ratio, through the above plurality of gears, so as to obtain a predetermined force multiplication gear ratio on the rope. More in particular, the rotation imparted to the primary shaft is transferred, through the above plurality of gears, to a secondary shaft in meshing engagement with a toothed crown internally associated to the rotor body.

A drawback associated to the winches of the known type, as described above, relates to the fact that they are not adapted to undergo extraordinary maintenance operations during sailing. This is due to the fact that the gears are housed into the rotor body, and they are associated to a support base intended to be secured in a suitable way above the boat deck. As a consequence, in order to access the gears and/or the other internal constructive components of the winch (bearings, bushings, pins, pawls, springs, etc.) during possible extraordinary maintenance operations, it is necessary to disassemble and remove the rotor body, thus preventing the winch not only from carrying out the function of rope pulling and/or clamping, but also that of deviation of the rope to a different area of the boat; this latter function would allow keeping the predetermined direction of the rope and thus, the position of the sail, unchanged.

The technical problem at the basis of the present invention is that of providing a winch which allows performing extraordinary maintenance operations also during sailing, concurrently maintaining the rope deviation function.

The invention thus relates to a winch for sailboats, comprising:

a stator body intended to be integrally mounted on a deck of a sailboat;

a rotor body, coaxially and turnably fitted onto the stator body along a primary axis X-X, and intended to house a rope for manoeuvring the sailboat;

a primary rotation driving shaft, coaxial to the primary axis X-X;

a secondary shaft for transmitting the motion to the rotor body;

a plurality of transmission gears between the primary shaft and the secondary shaft; characterised in that it comprises an upper unit intended to be mounted on the deck of the sailboat, said upper unit including the stator body and the rotor body, and a lower unit intended to be mounted below the deck of the sailboat, said lower unit including a gearbox housing said plurality of gears.

Unlike the winches described above with reference to the prior art, the winch of the present invention allows direct access to the gears from below deck, that is, without having to disassemble and/or remove the rotor body; the winch can thus maintain its function of rope deviation also in case it is necessary to perform extraordinary maintenance operations on it during sailing. It is thus possible to keep the predetermined directions of the rope and thus, the position of the sail, unchanged.

Advantageously, besides the gears, the lower unit comprises most of the other internal constructive elements of the winch (bearings, bushings, pins, pawls, springs, etc.); therefore, it is possible to operate from below deck also in case of breaking or damage of these elements without having to remove the rotor body.

Moreover, maintenance operations are facilitated because, thanks to the presence of the gearbox below deck, it is possible to work being repaired from atmospheric agents. Preferably, the lower unit is removably associated to the upper unit. Access to the gears is thus possible after having removed the lower unit and thus, the gearbox, from the upper unit.

Preferably, the gearbox comprises a lower chamber and an upper chamber and the plurality of gears is removably associated to said lower chamber. Even more preferably, the lower chamber is removably associated to the upper chamber.

Advantageously, therefore, the operations for removing and opening the gearbox to access the gears simply consist in removing the lower chamber of said box; in this way, almost all of the winch gears are extracted, which in turn can be extracted from the lower chamber to be replaced or repaired.

Preferably, the upper chamber comprises a side surface provided with a plurality of windows adapted to allow viewing the gears so as to check their state and/or the correct operation.

Preferably, the winch of the present invention comprises at least one spacing element interposed between the upper unit and the lower unit. Said winch can thus be mounted on different types of sailboats having different deck thickness, selecting the length of the spacing element or elements depending on the deck thickness.

Preferably, the winch of the present invention is adapted to be driven from below through a drive pedestal of the known type. In said configuration, the winch comprises a box for deviating the motion by 90° coaxially fitted along the primary shaft below the lower unit, and comprising a pair of conical toothed wheels directly active on the gears. Unlike the winches of the prior art, which between the deviation box and the gears provide for the use of a plurality of intermediate components (in particular, a vertical deviation shaft to the winch and two connection joints respectively between deviation box and vertical shaft, and between the latter and the gears), in the winch of the present invention the pair of conical toothed wheels of the 90° deviation box is directly associated to the gears, that is to say, without using any intermediate component; this simplifies the operations for installing the winch on the boat, and allows lowering the production costs of the same winch.

For the installation of the winch of the invention on the boat, a plurality of holes with small diameter are provided on the deck of the boat: in particular, it is necessary to form a first hole for the passage of the primary driving shaft (having, for example, a diameter of about 30 mm for a winch with a 300-mm diameter about), a second hole for the passage of the secondary shaft for transmitting the motion to the rotor body (having, for example, a diameter of about 60 mm), and one or more further holes for the passage of the spacing element or elements (having a diameter of 20 mm). Advantageously, the structure of the deck is less impaired with respect to what it could have been done using the winches of the prior art: in this last case, in fact, on the deck of the boat it is necessary to form a single hole with a larger diameter (typically, in the case of the example mentioned above, in the range of 300 mm), intended to house the gear support base.

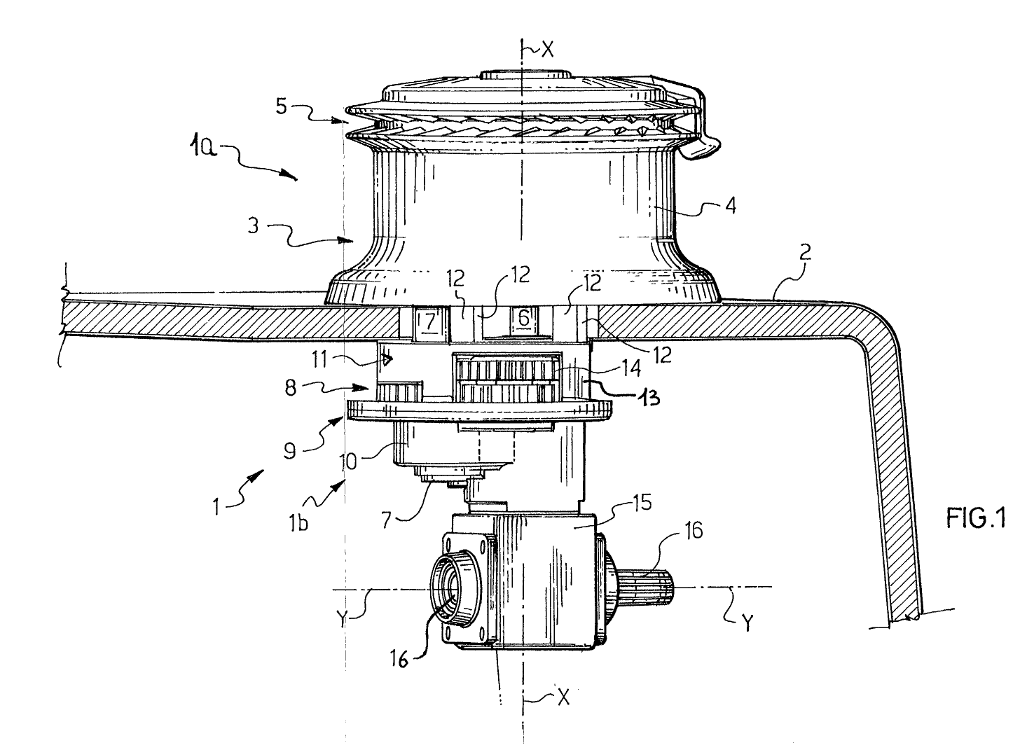

Further features and advantages of the present invention will appear more clearly from the following detailed description of a preferred embodiment made with reference to the drawing of FIG. 1, attached herewith, which shows a perspective view of a winch according to the present invention, mounted on the deck of a boat.

In said figure, reference numeral 1 refers to a winch according to the present invention. Winch 1, in particular, is a manual winch of the type driven from below, and its preferred application is on racing and/or cruising sailboats.

In its general constructive elements, winch 1 is substantially similar to a known manual winch driven from below, and thus its internal structural features will not be described in detail in the following description.

Winch 1 comprises an upper unit 1a, adapted to be mounted above a deck 2 of a sailboat (not shown), and a lower unit 1b adapted to be mounted below the deck 2 of the sailboat. The upper unit 1a comprises a stator body (not visible in the figure), or support, adapted to be fastened, though a base thereof, to the deck 2 of the sailboat, and a rotor body 3, or drum, turnably associated to the stator body 2 and intended to receive the windings of a rope for manoeuvring a sail of the sailboat during the pulling operations of the same rope. In particular, the rotor body 3 comprises a lower portion 4 intended to house the windings of the rope and an upper portion 5 intended to clamp the rope.

The rotor body 3 is coaxially fitted onto the stator body along a primary symmetry axis X-X, through the interposition of a plurality of roller bearings (not shown) intended to allow the relative rotation of the rotor body 3 with respect to the stator body.

In the embodiment shown in FIG. 1, the rotation is imparted from below (through proper drive pedestals) to a primary rotation driving shaft 6, coaxial to the primary axis X-X. The rotation is then transferred to the rotor body 3 through a secondary motion deviation shaft 7, substantially parallel to the primary shaft 6 and adjacent the rotor body 3.

In alternative embodiments (not shown), the rotation can be imparted from the top through a special driving handle intended to be removably housed into a suitable housing formed on the upper face of the rotor body 3. Between the primary shaft 6 and the secondary shaft 7, a plurality of motion deviation and reduction gears 8 are interposed.

Gears 8, together with most of the other internal constructive elements of the winch (bearings, bushings, pins, pawls, springs, etc.) are removably housed into the lower unit 1b of the winch, inside a gearbox 9.

Gearbox 9 comprises a lower chamber 10, which removably houses gears 8, and an upper chamber 11 removably associated to the stator body of the winch 1 through a plurality of spacing elements 12. The lower chamber 10 and the upper chamber 11 are removably associated to one another.

The upper chamber 11 comprises a side surface 13 provided with a plurality of windows 14 adapted to allow viewing gears 8.

Winch 1 also comprises a motion deviation box 15 coaxially fitted along the primary shaft 6 below the lower unit 1b. The deviation box 15 comprises a pair of conical toothed wheels at 90° meshing engagement, directly associated to gears 8 and intended to allow motion deviation from a deviation shaft 16, associated to the drive pedestal, to the primary rotation driving shaft 6 of the winch 1. The deviation shaft 16 indicated above is coaxial to an axis Y-Y, perpendicular to the central axis X-X of winch 1.

When mounting winch 1 on a boat, a first hole for the passage of the primary shaft 6, a second hole for the passage of the secondary shaft 7, and further holes for the passage of the spacing elements 12, are formed on the deck of the boat.

If extraordinary maintenance interventions must be carried out on winch 1 of the invention during sailing, it is possible to access gears 8 directly from below deck without having to disassemble and/or remove the rotor body 3; winch 1 can thus maintain its function of rope deviation, thus keeping the predetermined directions of the rope and consequently, the position of the sail, unchanged.

To access the gears it is sufficient to remove, from below deck, the lower chamber 10 of gearbox 9; in this way, almost all gears 8 of winch 1 are extracted (the secondary motion deviation shaft 7 remains associated to the upper chamber 11), which can in turn be extracted from chamber 10 to be replaced or fixed.

1. Winch for sailboats, comprising:
a stator body intended to be integrally mounted on a deck of a sailboat;
a rotor body coaxially and turnably fitted onto the stator body along a primary axis X-X and intended to house a rope for manoeuvring the sailboat;
a primary rotation driving shaft, coaxial to the primary axis X-X;
a secondary shaft for transmitting the motion to the rotor body;
a plurality of motion transmission gears between the primary shaft and the secondary shaft;
characterised in that it comprises an upper unit intended to be mounted above the deck of the sailboat, said upper unit including the stator body and the rotor body, and a lower unit intended to be mounted below the deck of the sailboat, said lower unit including a gearbox housing said plurality of gears.

2. Winch according to claim 1, wherein said lower unit is removably associated to said upper unit.

3. Winch according to claim 1, wherein the gearbox comprises a lower chamber and an upper chamber, wherein said plurality of gears is removably associated to said lower chamber.

4. Winch according to claim 3, wherein said lower chamber is removably associated to said upper chamber.

5. Winch according to claim 3, wherein the upper chamber comprises a side surface provided with a plurality of windows.

6. Winch according to claim 1, comprising at least one spacing element interposed between said upper unit and said lower unit.

7. Winch according to claim 1, comprising a motion deviation box coaxially fitted along the primary shaft below said lower unit and comprising a pair of conical toothed wheels directly active on said gears.
